(19) United States
(12) Patent Application Publication
(10) Pub. No.: US 2005/0097190 A1
(43) Pub. Date: May 5, 2005

(54) System and method for customized portal web pages

(76) Inventor: Aaron Abdelhak, New York, NY (US)

Correspondence Address: OSTROLENK FABER GERB & SOFFEN, 1180 AVENUE OF THE AMERICAS, NEW YORK, NY, 100368403, US

(21) Appl. No.: 10/698,699

(22) Filed: Oct. 31, 2003

(51) Int. Cl. G06F 15/16

(52) U.S. Cl. 709/217; 709/227

(57) ABSTRACT

A system and method for providing a personal Internet portal page to a user that displays at least some content selected by the user from a different Internet web site. The personal Internet portal page of the present invention displays at least some content from by the user. Moreover, the present invention provides a personal Internet portal page that displays only that content which is selected by the user. The present invention provides an Internet portal that obtains a live feed of data from one or more of servers. The data are provided in accordance with predefined criteria and presented in one or more encapsulated formats. The formats can be customized to accommodate individual preferences.

### FIELD OF THE INVENTION

The present invention relates generally to Internet web page development, and, more particularly, to a system and method for providing user customized portal web pages.

### BACKGROUND OF THE INVENTION

For years, Internet search engines have assisted millions of people using computers, or other Internet accessible devices, that operate web browser software to locate and access content provided on Internet web sites throughout the world. Many web sites located by search engines provide e-commerce functionality such that visitors can pay for goods and/or services directly over the Internet. Other web sites provide free or for-pay information content, such as news, entertainment, weather and financial markets information.

A typical search engine includes a web site having a user interface for visitors to submit a search request comprising terms describing the web sites the visitors wish to access. A typical search engine also includes a search engine database that stores information regarding other Internet web sites. The database is automatically referenced when a search request is submitted by a user, typically caused by the user entering search terms and then selecting a graphic icon, such as a windowed button. The database provides the names and descriptions of web sites that match the search request, and the search engine web site formats the names and descriptions of the matched web sites, typically as hyperlinks, thereby enabling the users to review and access the respective sites.

Search engines use, for example, computer software applications known as “web crawlers,” “spiders” and “software robots” (also known as “softbots” or “bots”) that automatically establish communication sessions with web sites in order to retrieve site-descriptive information, for example, in metatags and other content typically formatted in the hypertext markup language (“HTML”). The retrieved information is stored in the search engine database and, typically, the information includes uniform resource locators (“URLs”) and/or Internet Protocol (“IP”) addresses of the web sites. The phenomenal growth in the number of Internet web sites has resulted in search engine databases storing millions of records, each representing a unique web site. As a result, a user submitting a broad search request in a search engine can be provided with hyperlinks to hundreds of thousands of web sites. Users must sift through the plethora of results to locate desired content.

Over time, search engine web sites, such as YAHOO, EXCITE and MSN, have offered Internet-related functionality beyond that offered by the above-described, typical search engine. Proprietors of Internet search engines recognize that users desire immediate access to up-to-the-minute content without the inconvenience of submitting search terms, followed by using a mouse or other pointing device to click a hyperlink in order to view the content. Accordingly, search engine web sites have evolved and dedicate a portion of the display screen to up-to-the minute content, such as stock quotes and news headlines, from third-party web sites. Users are provided instantaneous access to current information content without having to search and access a different web site. A web page that provides search engine functionality, along with a information content provided from a third party, for example, www.cnn.com, is known in the industry as a “portal.”

Proprietors of portals recognize that users prefer to customize the computing environment in which they operate. Accordingly, portals are available, for example, from my.yahoo.com and my.msn.com that are, to a degree, customizable to a user's preferences. Typically, a user “registers” with a proprietor of a portal by providing a unique user name and password, in addition to providing other information desired by the proprietor. Once registered, a user selects options to choose which content is displayed in the portal, and also to manipulate basic formatting of the display of the portal, such as colors and text font types. Typically, the registered user is presented with his personal portal after supplying his user name and password.

Referring to the drawing figures, in which like designators refer to like elements, there are shown in FIGS. 1A and 1B two example prior art Internet web portals 100. The depiction shown in FIG. 1A is the default portal layout provided for non-registered users, and located at the web site, http://my.msn.com. The depiction shown in FIG. 1B is the default portal layout provided for non-registered users and located at the web site, http://my.yahoo.com. As shown in FIGS. 1A and 1B, content boxes 2 contain current information content from a plurality of sources. For example, news photos and headlines, local weather and weather from a plurality of cities, and stock quotes are provided. Much of the content boxes 2 is provided as a hyperlink. Further, advertisement links 4 show advertisements from various third parties. User login box 6 enables a user to submit a user name and password in order to customize the design of a portal page, or to access an existing portal 100. Further, portal display configuration box 8 enables the user to choose content, colors, and a layout for portal 100.

Many web sites, including Internet web portals, contain advertisements for various goods and services from third parties. Advertising is an effective way to defray the high cost of providing Internet-related services. The advertisements are usually formatted as digital graphic files, such as JPEG files, and occupy portions of the web browser display screen where viewers are likely to look, such as at the top and bottom of a web page. The advertisements frequently include hyperlinks to e-commerce web sites where goods or services can be purchased.

Users often find advertisements in web sites to be undesirable because they are distracting. The sophistication of Internet web site development tools, such as COLDFUSION and DREAMWEAVER, as well as the evolution of class files in the JAVA programming language, enable developers to add motion and other visual effects to web site advertisements in the hope of gaining users' attention. Also, hyperlinks in web site advertisements are often mistakenly selected, thereby causing further interruption by presenting different web pages.

As shown in FIGS. 1 and 1A, advertisement links 4 occupy a significant amount of the display. For example, advertising is shown for the Internet web portal service provider (“HP”), the Internet portal itself (“my.msn”), a credit card company, broadband Internet access, and an web promotion to win money. As noted above, advertisement links 4 are typically flashy and detract from the user's experience.

Users of Internet portals such as my.msn.com and my.yahoo.com desire greater flexibility in content and design than that currently provided. U.S. patent application Publication No. 2002/0156812, entitled “Method and System for Assembling Concurrently-Generated Content,” teaches providing content in a portal that is hosted by a plurality of distinct servers in response to a single request from a client. This reference attempts to increase user flexibility with respect to Internet portal content. International Patent Publication No. WO 02/01388, entitled “Portal Server that Provides a Customizable User Interface for Access to Computer Networks,” teaches providing a plurality of network resources via an administration interface in which a user selects layout styles and schemes, as well as content from a set of servers to be displayed in a portal. Further, U.S. patent application Publication No. 2003/0101412, entitled “User Aggregation of Webpage Content,” teaches methods and products for a user to identify a target web page which is virtually dissected to extract specific content therein. The content is then displayed with other such extracted content in a portal.

These prior art references, however, are not tools for the masses of Internet users. Systems that provide extreme degrees of flexibility envisioned for the user are simply too complex and impractical to be implemented in a large scale environment, such as that supported by YAHOO and MSN. The ability to support millions of individual users who identify virtually any web site, and then parse the code therefrom in order to extract specific portions to implement custom portal content is simply too daunting a task for large-scale applications.

### SUMMARY OF THE INVENTION

To be Completed with Claims.

The present invention provides a compromise between the overly complex prior art portal system that provides extreme user customization on one hand, and the more simple, but much less flexible, high user volume portal on the other. The present invention provides improved customization and with fewer limitations of high user volume portals with respect to the portal server pushing its own advertising promotions on users.

The present invention provides a personal Internet portal page to a user that displays at least some content selected by the user from a different Internet web site. Further, the personal Internet portal page of the present invention displays at least some content from by the user. Moreover, the present invention provides a personal Internet portal page that displays only that content which is selected by the user.

The present invention provides an Internet portal that obtains a live feed of data from one or more of servers. The data are provided in accordance with predefined criteria and presented in one or more encapsulated formats. The formats can be customized to accommodate individual preferences.

The present invention further allows a user to upload content, such as still and moving images, audio files and other information content to a personal storage cache that can be accessed on the portal.

The present invention further provides a portal that allows a user to display information from one or more e-mail accounts that may be unrelated to the service providing the portal.

The present invention further provides a portal that allows a user to upload personal information to a personal information management component of the portal. For example, a calendar of events, personal contacts, notes and calculator are available as the portal of the present invention.

The present invention further provides a portal that substantially automatically displays a predetermined web site for a predetermined amount of time, and then displays another predetermined web site, or, alternatively, returns to the portal, substantially automatically.

The present invention also provides a portal that qualitatively analyzes information displayed therein, and, in response to data-related events such as changing information, provides an alert for the user that a data-related event has occurred.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIGS. 1A and 1B show prior art Internet web portals;

FIG. 2 shows an example hardware arrangement of a preferred embodiment of the present invention;

FIG. 3 is a block diagram illustrating the functional elements in an example information processor;

FIG. 4 is an example web site display screen enabling a user to access a personal Internet portal page;

FIG. 5 is an example web site display screen that provides selections for a user to design a personal Internet portal page;

FIG. 6 is an example personal Internet portal page designed in accordance with the present invention;

FIG. 7 is a high level flow chart that illustrates example steps associated with designing and accessing an Internet web portal in accordance with the present invention;

FIG. 8 is a flow chart that identifies steps associated with a user designing a personal Internet portal page; and

FIG. 9 is a flow chart that identifies steps associated with providing a personal Internet portal page for a user.

### DETAILED DESCRIPTION OF PREFERRED EMBODIMENTS OF THE INVENTION

The present invention provides a personal Internet portal page to a user that can display at least some content selected by the user from a third-party Internet web site. Further, the personal Internet portal page of the present invention can display at least some content from by the user. Moreover, the present invention provides a personal Internet portal page that displays only content that is identified by the user. In other words, no advertisements or other extraneous elements are provided in the personal Internet portal page, without the user's expressed request therefor.

As used herein, the terms “user” and/or “user terminal” refer, generally, to a person and/or device operated by a person that establishes a communication session over a network with another device. Also as used herein, the term, “personal Internet portal page” refers, generally, to an Internet portal that is customizable by a user in accordance with the teachings provided herein.

The present invention provides a user who registers with an information processor, for example, by providing at least a user name and password, with tools for developing a personal Internet portal page to suit the desires of many different people. After a user registers, the user can design his own layout and appearance for the portal page. The user is preferably able to resize sections portal page, and to select colors, fonts and point sizes of content displayed in the portal page. Further, the user can capture fast moving information such as a moving stock ticker, by selecting predetermined Internet sources of current and up-to-date information.

Preferably, menu selections are provided to the user for popular sources of content, including national and international news sources, financial market information, entertainment information, sports information, weather information, and e-mail-related information. Preferably, a user makes portal design choices, and the information content is provided in the personal Internet portal page, when the user accesses the page.

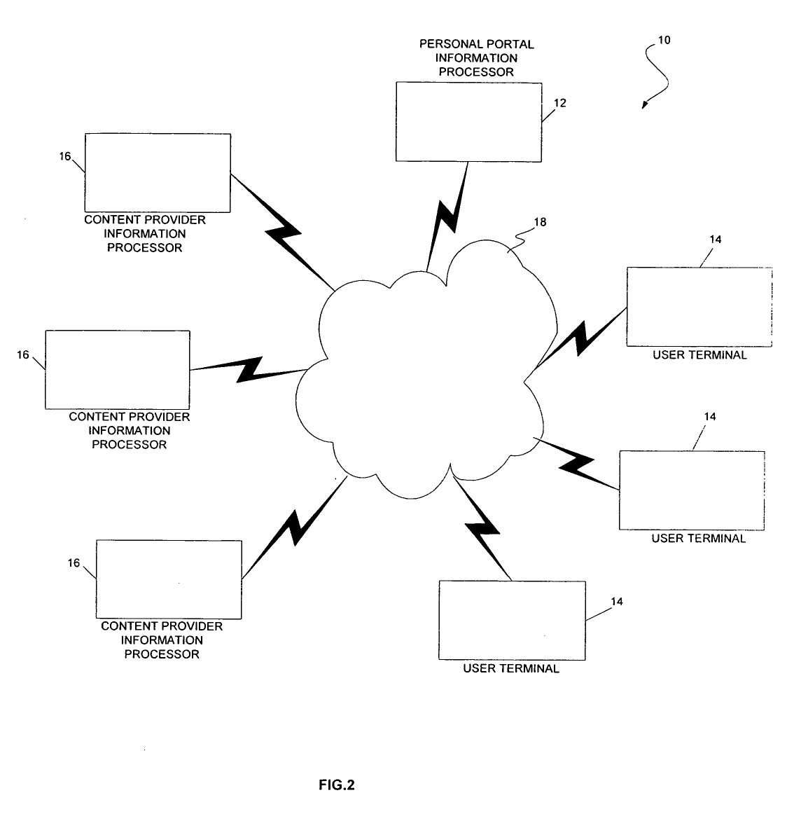

FIG. 2 shows an example of a preferred embodiment of the present invention, including a hardware arrangement for providing personal Internet portal pages, and referred to generally as system 10. System 10 comprises at least one personal portal information processor 12, at least one user terminal 14, and at least one content provider information processor 16, each of which is adapted to access and communicate over communication network 18. Personal portal information processor 12 preferably provides personal Internet portal pages for registered users operating user terminals 14.

Personal portal information processor 12 preferably includes all databases necessary to support the present invention. However, it is contemplated that personal portal information processor 12 can access any required database via communication network 18 or any other communication network to which personal portal information processor 12 may be coupled. Communication network 18 is preferably a global public communication network such as the Internet, but can also be a wide area network (WAN), local area network (LAN), or other network that enables two or more computers to communicate with each other.

In the preferred embodiment, personal portal information processor 12, user terminal 14 and content provider information processor 16 are any devices that are capable of sending and receiving data across communication network 18, e.g., mainframe computers, mini computers, personal computers, laptop computers, a personal digital assistants (PDA) and Internet access devices such as Web TV. In addition, personal portal information processor 12, user terminal 14 and content provider information processor 16 are preferably equipped with a web browser, such as MICROSOFT INTERNET EXPLORER, NETSCAPE NAVIGATOR and the like. Information processors 12, 14 and 16 are coupled to communication network 18 using any known data communication networking technology.

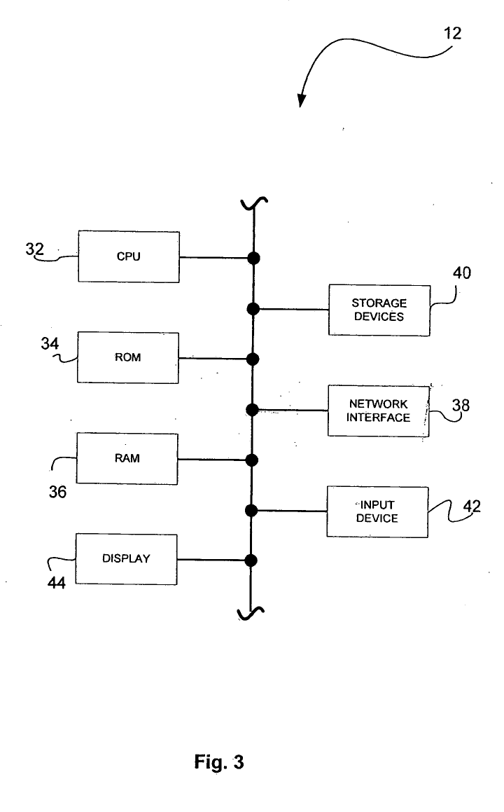

As shown in FIG. 3, the functional elements of each personal portal information processor 12 are shown, and include one or more central processing units (CPU) 32 used to execute software code and control the operation of personal portal information processor 12, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of personal portal information processor 12 need not be physically contained within the same chassis or even located in a single location. For example, storage device 40 may be located at a site which is remote from the remaining elements of personal portal information processor 12, and may even be connected to CPU 32 across communication network 18 via network interface 38. Personal portal information processor 12 preferably includes a memory equipped with sufficient storage to provide the necessary databases, forums, and other services as well as acting as a web server for communicating hypertext markup language (HTML), Java applets, Active-X control programs or the like to user terminals 14. Personal portal information processor 12 is arranged with components, for example, those shown in FIG. 3, suitable for the expected operating environment of personal portal information processor 12. The CPU(s) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of personal portal information processor 12 shown in FIG. 3 are of the same categories of functional elements present in user terminals 14 and content provider information processor 16. However, not all elements need be present in the user terminal 14 and/or the content provider information processor 16. For example, storage devices, in the case of PDA's, and the capacities of the various elements are arranged to accommodate the expected user demand. For example, CPU 32 in user terminal 14 may be a smaller capacity CPU than the CPU present in the personal portal information processor 12. Similarly, it is likely that the personal portal information processor 12 will include storage devices of a much higher capacity than storage devices present in user terminal 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., personal portal information processor 12), system 10 is not limited to such a configuration. It is contemplated that system 10 is arranged such that user terminal 14 communicates with and displays data received from personal portal information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on personal portal information processor 12 and user terminal 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on personal portal information processor, 12 and user terminal 14 regard the process of communicating data across communication network 18 and processing the data such that the data are viewed on a display 44, for example by using a web browser and the like. As is common with web browsing software, the display 44 on user terminal 14 presents sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

As used herein, the term, “module” refers, generally, to one or more discrete components that contribute to the effectiveness of the present invention. Modules can operate or, alternatively, depend upon one or more other modules in order to function.

The present invention is directed to providing a personal Internet portal page that can be customized by a user. A registered user can access his personal Internet portal page by establishing a session with a portal server that provides personal Internet portal pages, and, thereafter, by submitting an authorized user name and password in a log-in portion in a web browser display screen. Unregistered users are preferably not able to access a personal Internet portal page. Once a registered user submits his or her user name and password (i.e., logs in), an identifier, such as an Internet cookie, is preferably stored on user terminal 14 and referenced by personal portal information provider 12 in the future. Once the cookie or other identifier is referenced, the user can elect to bypass the log-in portion of the web page and, instead, be presented with his personal Internet portal page, substantially automatically.

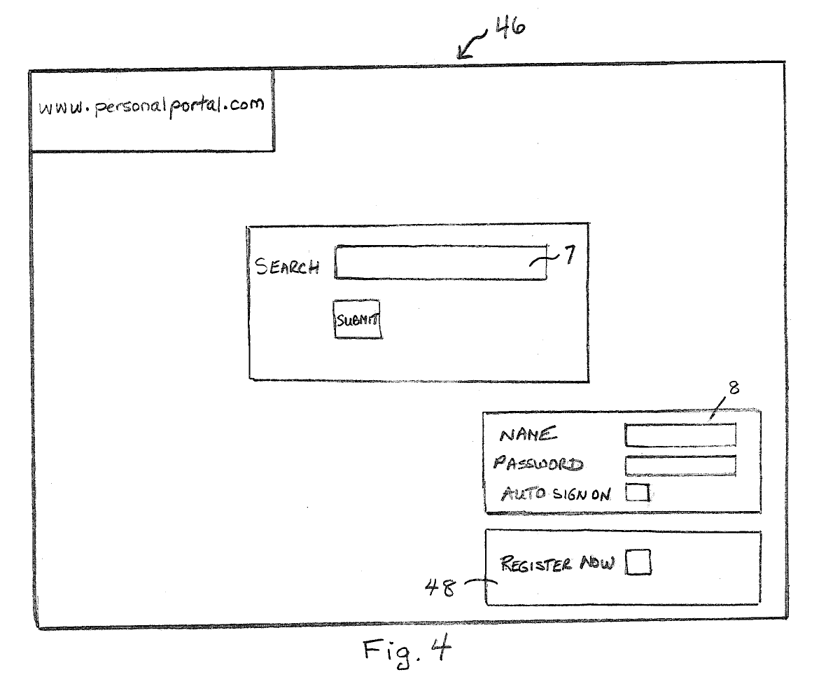

FIG. 4 is an example display screen 46 that is presented by personal portal information processor 12 when a user terminal 14 establishes a communication session therewith. In a preferred embodiment, display screen 46 includes search text box 7 that provides users with search engine-related functionality. Preferably, personal portal information processor 12 employs a database, a web crawler and other technology common to prior art search engines to enable a user to search for and locate content on Internet web sites. The search engine preferably sorts a list of web pages represented by a user's search criteria according to a user's preference, for example, by the degree of relevance each page has with respect to the user's search criteria.

Display screen 46 also includes login box 6 for registered users to submit user names and passwords. Unregistered users can select Register Now hyperlink 48 to submit registration information, such as a new user name and password.

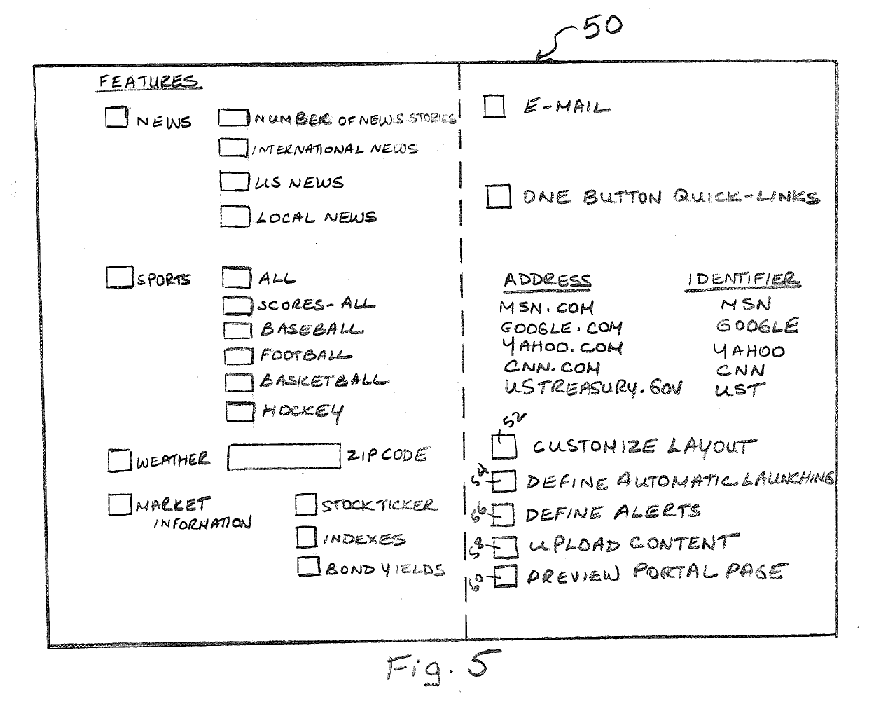

FIG. 5 is an example personal Internet portal page design display screen 50 that is preferably provided to an authorized user of the present invention. Display screen 50 preferably provides selections for the user to design a personal Internet portal page. In the example embodiment shown in FIG. 5, a user can choose the services provided by personal portal information processor 12 by selecting from menu choices and icons representing information, and the placement of such selected information on the user's personal Internet portal page. The services offered for the user's selection include news, sports scores, weather information, market information, e-mail, and hyperlinks to preferred web sites.

In the example embodiment design display screen 50, the user selects customize layout button 52 to access tools to define the layout of the personal Internet portal page. For example, the user can drag lines in a blank display screen that represent portions of the personal Internet portal page. The user can also select content to be placed in one or more portions of the personal Internet portal page. As noted above, display screen 50 (as well as other example embodiments shown in the reference figures) is merely illustrative of choices and options available to a registered user. Of course, one skilled in the art will recognize that many other choices and features can be provided for a registered user to include in his personal Internet portal page.

Unlike overly ambitious prior art systems that enable a user to select any web site content to be included in a portal, the present invention preferably restricts the user to predefined Internet content provided by the service provider. The present invention enables a user to select from list of predefined Internet content sources, as well as to select from a plurality of layout and display options. Also shown in FIG. 5, Define Automatic Launching Button 54, when selected, allows a user to identify particular web sites that are to be displayed in accordance with a user's preference. For example, a user can instruct personal portal information processor 12 to display the web site, www.cnn.com, every thirty minutes for a five minute interval, and, thereafter, display the user's personal Internet portal page. Further, a user can identify a series of web sites that are substantially automatically displayed in a sequence. For example, following www.cnn.com, www.nytimes.com is displayed for five minutes and then the user's personal Internet portal page once again is displayed.

Moreover, the present invention preferably provides alerts to a user, such as a flashing in a display screen or an audible tone, that notify the user to an event, such as changing information. For example, the user selects Define Alerts Button 54 to program an alert that is provided whenever a change in a score of a sports game occurs. Thus, the user can focus on some activity, and after a team scores in a sports game, the user's attention is alerted, via the present invention, to the event.

Another feature provided by the present invention, and shown in FIG. 5, is the ability for a user to upload personal content to the personal portal information processor 12. For example, the user selects upload content button 58, and is, thereafter, presented with a mechanism to upload, for example, digital still and/or moving images and audio files. Preferably, personal portal information processor 12 allocates storage space for personal content uploaded by users. Once a user's personal content is uploaded to the personal portal information processor 12, the user is preferably provided tools to identify how the personal content is to be incorporated in the user's personal Internet portal page. For example, a digital image of a user's family can be selected for a background (wallpaper) of the personal Internet portal page. Alternatively, a portion of the personal Internet portal page can be allocated for an image uploaded by the user. Also, an audio file, such as a user's favorite MP3 file, can be played each time the user accesses his personal Internet portal page. Of course, one skilled in the art will recognize that other uses for personal content in accordance with a personal Internet portal page are available.

In addition to multimedia content, such as digital image and audio files, the present invention preferably enables a user to upload information content to the personal portal information processor 12. For example, a user can provide business related information directed to a specific project. Such information, for example, represents a number of parties that have been assigned responsibilities with respect to the project. The personal portal information processor 12 preferably provides project management software that can be integrated into the user's personal Internet portal page. Moreover, a plurality of users can be provided with information directed to their respective responsibilities for the project in their own personal Internet portal pages. In this way, the present invention provides improved access to information over prior art Internet portals.

While a user is defining his personal Internet portal page via the tools available in display screen 50, the user can select Preview Portal Page Button 60 to view a representation of his personal Internet portal page. In this way, the user can determine whether the personal Internet portal page design is to his liking, and further, can modify the design by adding, removing or changing content and the respective layout thereof.

Preferably, specifications representing a user's personal Internet portal page are developed using display screen 50. The specifications used to generate the user's personal Internet portal page can be stored on personal portal information processor 12, or, alternatively, the specifications can be stored locally on the user terminal 14. In one example embodiment, each user's personal Internet portal page is generated, and then stored on the personal portal information processor 12. Thus, when the user establishes a session with personal portal information processor 12, the user terminal 14 is routed to the location of his respective personal Internet portal page. Alternatively, each user's personal Internet portal page is generated dynamically by personal portal information processor 12, for example, by referencing design specifications and then serving the respective personal Internet portal page.

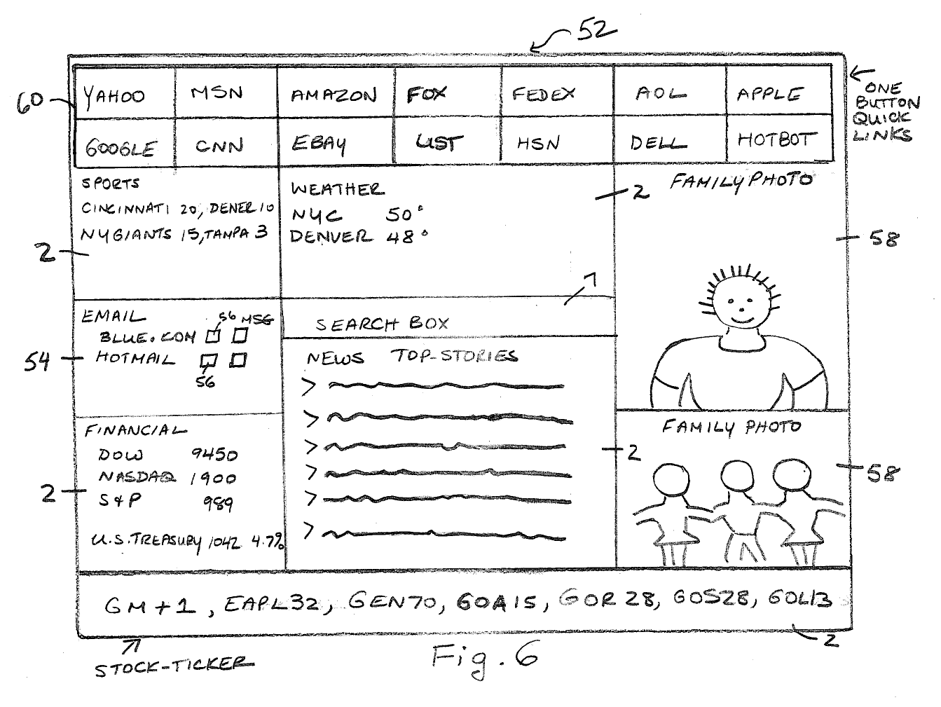

FIG. 6 shows an example personal Internet portal page 52 that is preferably presented to a authorized user who has previously designed a personal Internet portal page, for example, via display screen 50. Personal Internet portal page 52 includes features that are commonly found in prior art Internet portals. For example, content 2 is displayed that shows sports scores, financial markets information, real-time stock values, weather information and news headlines. Also, e-mail box 54 displays information directed to the user's various e-mail accounts. For example, a user has two e-mail accounts (depicted in FIG. 6 as blue.com and hotmail.com) and an indicator is provided that shows whether new messages have been received by the respective accounts. The user can select button 56 to launch an e-mail client software application in order to view a respective e-mail message, and/or to perform other e-mail-related functionality (e.g., composing a new message, replying to a message, managing e-mail folders, or the like).

Also as shown in FIG. 6, personal content boxes 58 illustrate digital images that have been uploaded by the user and displayed in the user's personal Internet portal page 52. Thus, the user has the ability to personalize his personal Internet portal page by including multimedia content that was previously uploaded by the user.

Also shown in the example embodiment in FIG. 6, hyperlinks section 60 represent a plurality of web sites that the user has defined during set up (FIG. 5), and provides one click access to the respective pages. In the example shown in FIG. 6, the user has identified Yahoo, Google, MSN, CNN, Amazon and others to be displayed upon selection of each respective hyperlink. Hyperlinks section 60 affords users an easy and simple way to “surf” to a user's preferred web sites. Hyperlink section 60 is an improvement over typical prior art web browser features, such as a favorites folder, due to the convenient placement of the hyperlinks, and the respective ease by which a user selects the hyperlink.

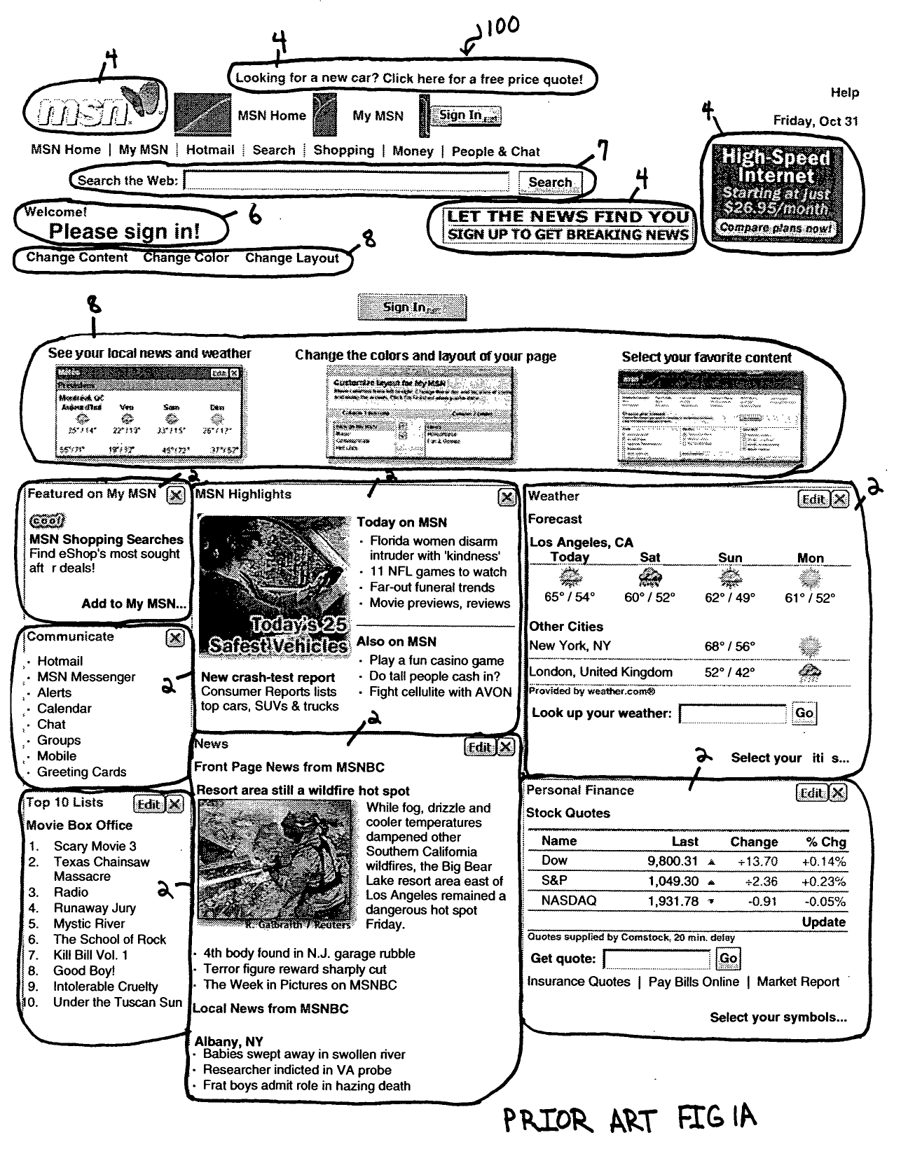

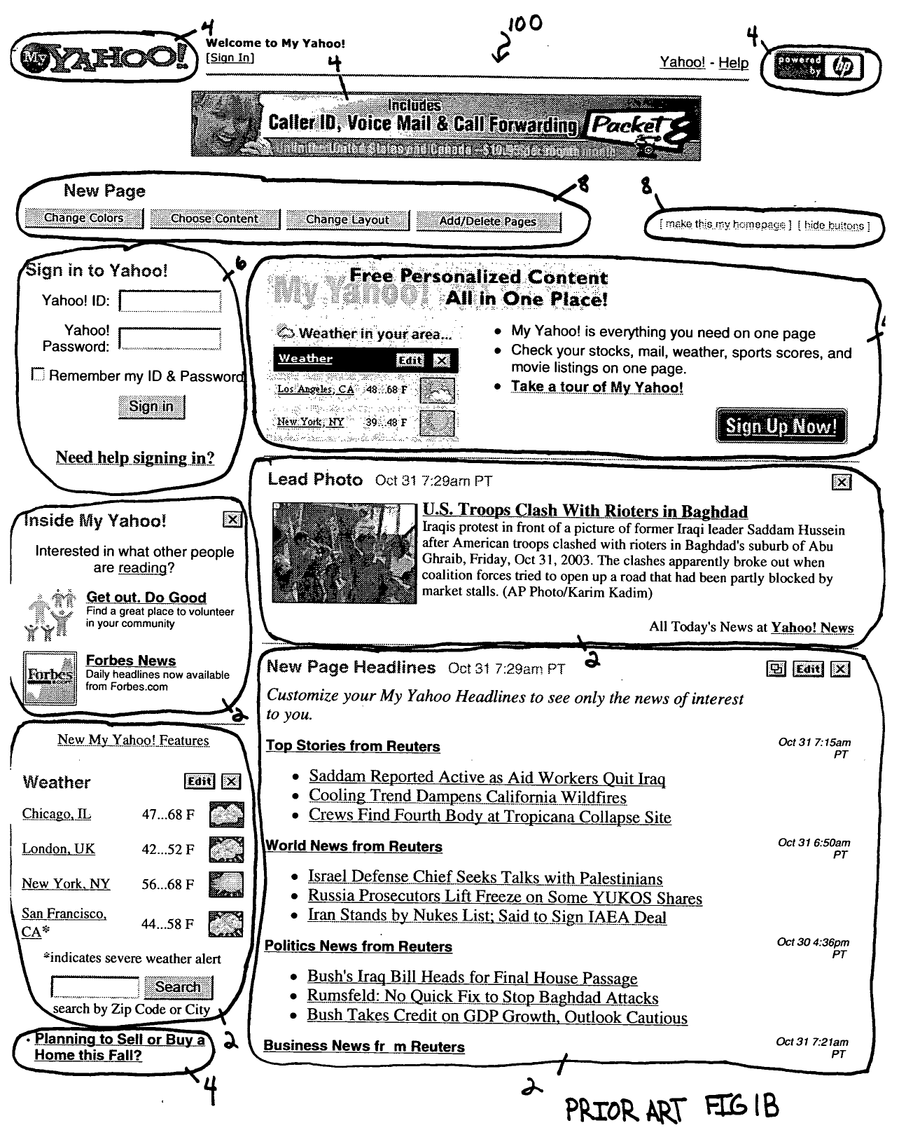

As shown in the example personal Internet portal page 52, advertisements 4 (FIGS. 1A and 1B) are conspicuously absent. There is no indication of personal portal information processor 12, or any third party offerings of goods and/or services. Of course, if a user expressly requests advertisements 4 in his or her personal Internet portal page, the present invention can accommodate such additions. As will be apparent to one skilled in the art, the present invention enables a user to define a personal Internet portal page in accordance with his or her preferences, without the requirement of advertisements 4 being placed thereon.

Of course, one skilled in the art will recognize that the example personal Internet portal page 52, shown in FIG. 6, is merely illustrative of a single example, and that, in accordance with the present invention, countless variations of personal Internet portal pages can be designed by users in accordance with the teachings herein.

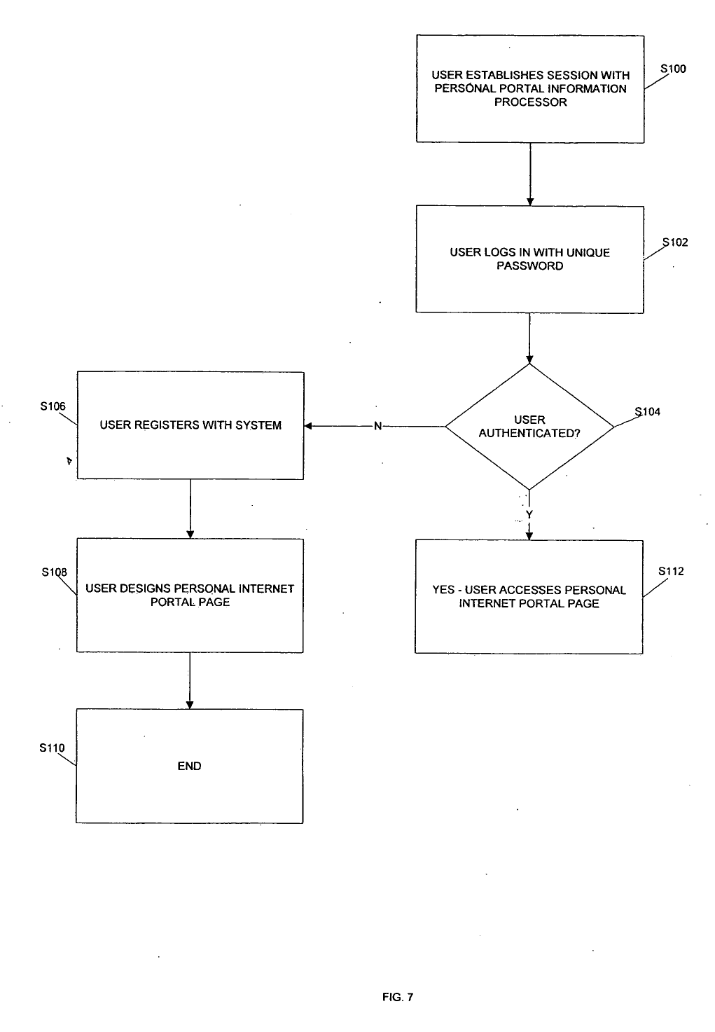

FIG. 7 is a high level flow chart that illustrates example steps associated with designing and accessing a personal Internet portal page in accordance with the present invention. The example flowcharts shown in FIGS. 7-9 represent a preferred sequence of events, it being understood that steps may be added, removed or changed without departing from the spirit of the present invention.

In step S100, a user establishes a communication session with the personal portal information processor 12. This is accomplished, for example, by the user entering a uniform resource locator (“URL”) in a web browser display screen. Thereafter, the user is presented with web site display screen 46 (FIG. 4). The user attempts to log in to the personal portal information processor 12 to access or design a personal Internet portal page by providing a unique user name and password (step S102). In step S104, a determination is made by personal portal information processor 12 whether the user name and/or password enables the user access to a personal Internet portal page. In the event the user name and/or password is insufficient, the user is preferably prompted to register with personal portal information processor 12, for example, by selecting Register Now Button 48 (FIG. 4). The user registers with personal portal information processor 12, for example, by providing a unique user name and password (step S106). Thereafter, in step S108, the user is afforded tools, substantially as described above, for designing a personal Internet portal page. If, in step S104, the user is determined to have sufficient rights, then, in step S112, the user accesses his personal Internet portal page.

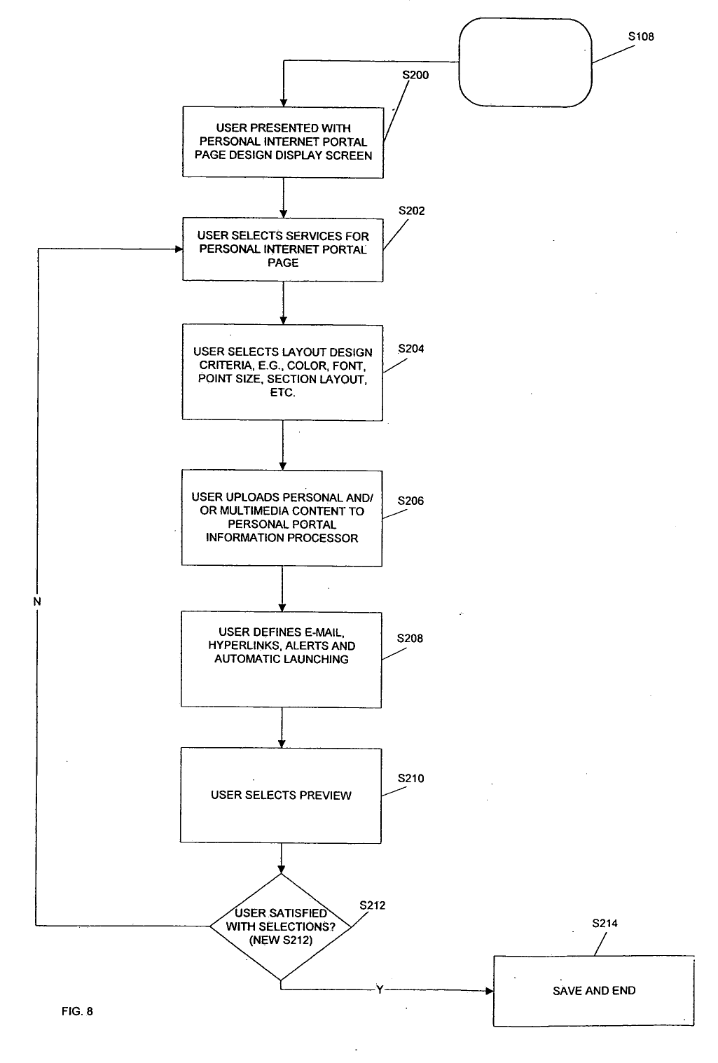

FIG. 8 shows a flowchart that identifies, in greater detail, example steps associated with designing a personal Internet portal page in accordance with the present invention. The steps shown in FIG. 8 branch from the step S108 (FIG. 7), designing a personal Internet portal page.

In step S200, a personal Internet portal page design display screen 50, such as shown in FIG. 5, is displayed in the user's web browser. Using the design display screen 50, the user selects choices for services that he desires to appear on his personal Internet portal page (step S202). Additionally, the user selects a preferred layout for the personal Internet portal page (step S204). For example, the user selects predefined schemes that provide variations of location of services, font types, point size and colors for the respective sections where the services are to be provided. In step S204, the user is also afforded an opportunity to modify the layout and design of any portion of the personal Internet portal page.

Continuing with the flowchart in FIG. 8, in step S206, the user uploads personal content to personal portal information processor 12 for use in the respective personal Internet portal page 52. For example, the user uploads digital images of his family, and an audio file of his favorite song. If the user so desires, he selects the layout for content uploaded in step S206, substantially as described in step S204. In step S208, the user defines a portion of his personal Internet portal page to contain information regarding the user's e-mail accounts. Further, the user defines a series of hot links to be displayed, for example, in hyperlinks section 60 (FIG. 6). In step S208, the user also defines alerts to be presented, for example, in the event of changing information. The user also defines web pages that are to be automatically launched in accordance with predetermined conditions, such as the passage of a predetermined amount of time. In step S210, the user selects a choice for previewing his personal Internet portal page that represents the selections made up to this point. Of course, one skilled in the art will recognize that the user can select the choice for previewing his personal Internet portal page at any time during the design process, and is not restricted to a single preview after the choices in steps S202-S208 are complete.

In step S212, the user makes a determination whether or not he is satisfied with the selections that have been provided up to this point. If the user determines, in step S212, that he wants to modify certain selections, for example, the layout or the actual content that is displayed, the process loops back to steps S202 and the user is provided the opportunity to modify his previous selections. In the event the user is satisfied with the selections made to this point, the process continues to step S214, wherein the personal Internet portal page layout and contents are saved and the process ends.

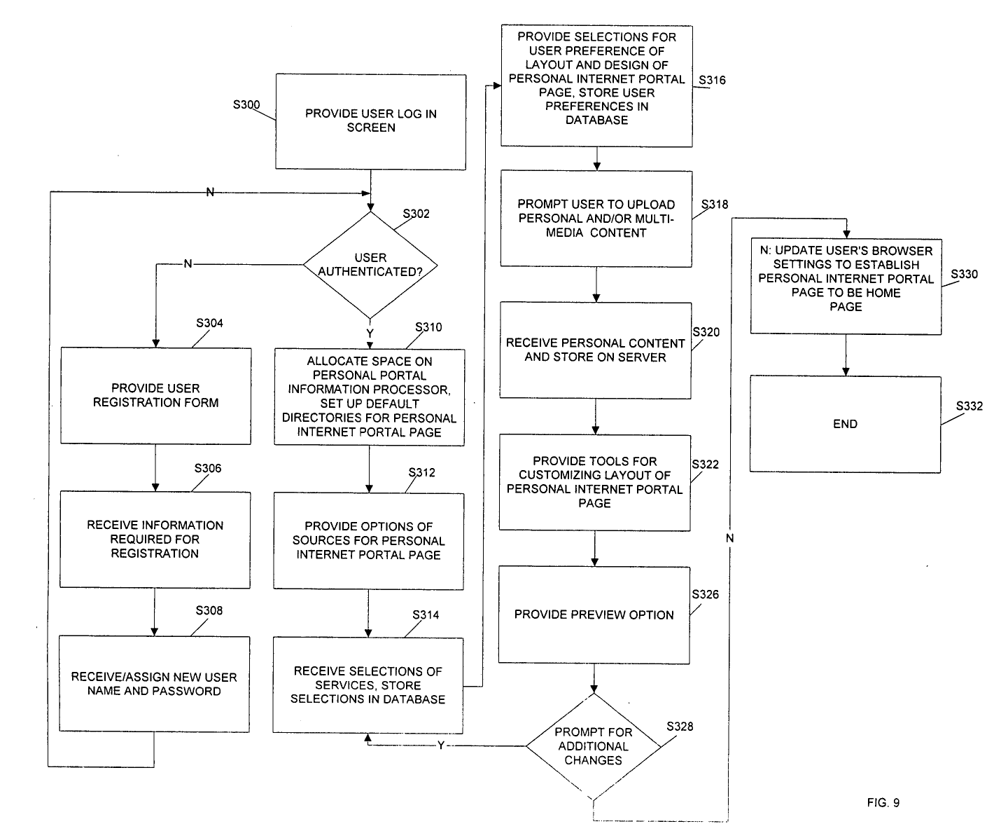

FIG. 9 shows a flowchart comprising steps associated with personal portal information processor 12 providing development and presentation of a personal Internet portal page for a user.

In step S300, personal portal information processor 12 provides an Internet web page 46, substantially as shown in FIG. 4. After receiving a user name and password from a user, personal portal information processor 12 determines, in step S302, whether the user is registered and/or authorized to access a personal Internet portal page. If, in step S302, personal portal information processor 12 determines the user is not registered, then a registration form is preferably provided to the user in the form of a data entry screen (S304). Personal portal information processor 12 preferably receives registration information from the user, in step S306, and, thereafter, in step S308, receives and/or assigns a new user name or password for the respective user. Thereafter, the process loops back to steps 302.

If, in step S302, personal portal information processor 12 determines the user is registered and/or authorized to design a personal Internet portal page, then, in step S310, personal portal information processor 12 allocates storage space for the respective user, and sets up a default directory where the user's personal Internet portal page will be stored. Thereafter, options for designing the personal Internet portal page, including sources of Internet content are provided (step S312). In step S314, personal portal information processor 12 receives user selections directed to content for the personal Internet portal page, and stores the selections in a database. Thereafter, personal portal information processor 12 provides selections to the user for design layout preferences, including, font type, point size, colors and the like (step S316). In step S318, the personal portal information processor 12 prompts the user to upload personal and/or multimedia content to the user's allocated storage space. In step S320, the content from the user is received and stored on the personal portal information processor 12. In step S322, tools are provided to the user for customizing the layout and appearance of the personal Internet portal page. For example, the user can size particular portions of the display screen, can change colors, font types and the like. In step S324, personal portal information processor 12 provides a preview of the personal Internet portal page for the user.

Thereafter, a prompt is provided that asks the user, in step S326, whether additional changes to the personal Internet portal page by the user. If the user indicates that additional changes are desired, then the process loops back to step S312 and additional options for services and content is provided. Alternatively, if the user is satisfied with the personal Internet portal page layout and design, then the process continues to step S328 and the user's Internet web browser is modified to reflect the personal Internet portal page as the default home page for the user. Thereafter, in step S330, the process ends.

Thus, a user can customize a personal Internet portal page by selecting information desired to be displayed on his screen, for example, content, color, size and location. Personal portal information processor 12 saves the configuration, and displays the personal Internet portal page whenever the user logs in.

As noted above, in an alternative embodiment, information directed to the user's design choices are saved, for example, in a configuration file, and referenced each time the user establishes a session with personal portal information processor 12. Using server side technology (e.g., JAVA SERVLETS or MICROSOFT ACTIVE SERVER PAGES) the user's personal Internet portal page is created dynamically. Further, the user can create his or her own personal Internet portal page that only contains items desired by the user, and in the format desired by the user. No advertisements of any kind will be imposed on the user, thereby assuring a truly custom personal portal. In an alternative embodiment, personal portal information processor 12 offers a personal Internet portal page by way of a customized Internet browser that a user downloads from processor 12. The browser contains instructions to display a personal Internet portal page in accordance with the user's specifications.

In addition to standard search engine technology, it is envisioned that the present invention will also offer e-mail accounts to users thereof with the ability to create quick links to other e-mail accounts that allow single click access to each respective e-mail account. Moreover, as described above, information directed to each respective e-mail account, such as the number of new incoming messages, will be provided.

Thus, the present invention provides a universal tool to suit the desires of many different people in the development and customization of a personal portal page. Users can design their own layouts and are not limited, for example, to the size of portions of a display screen, font types, colors, text point sizes and the like. Further, the present invention provides fast moving and changing information in a convenient display. In a preferred embodiment, this is accomplished by arrangements with content provider information processor 16 and personal portal information processors 12. In other words, instead of attempting to dissect the contents of a web site in order to provide a customized display thereof, as found in the prior art, personal portal information processor 12 receives data from content provider information processor 16 in accordance with predefined formats. The content is then provided to users in accordance with predefined criteria and encapsulated in a format allowed by personal portal information processor 12.

Moreover, the present invention supports receiving content from users, such as multimedia files and data from various applications, including, personal information management systems, spreadsheets, databases and word processors in order to provide a current, up-to-date view of important personal and/or professional information.

The present invention includes various business models for providers of Internet-related services. For example, Internet service providers and/or web host service providers offer customers the ability to design personal Internet portal pages in accordance with the present invention. As noted above, advertisements, promotions and other extraneous content are not forced upon the users. In order to generate revenue, the present invention employs a variety of pricing schemes in order to generate profit. The following discussion represents alternative business models available under for the present invention.

Internet-related service providers who offer users the tools for personal Internet portal pages in accordance with the present invention charges a flat fee, for example, a monthly fee or annual fee, to the user. The flat fee includes, for example, access to the tools for designing a personal Internet portal page, and access to the personal Internet portal page. Alternatively, the user is charged a respective fee for various services. For example, the user is charged one amount to initially design a personal Internet portal page. The user is charged a another amount each time the user makes modifications to the personal Internet portal page. Further, the user is charged yet another amount for uploading content to personal portal information processor 12, with the amount determined based on the amount of information uploaded by the user.

Alternatively, the user is charged rates that are determined by the content that is included in his personal Internet portal page. For example, the personal Internet portal page may include news stories that have been archived by a news source. Preferably, personal portal information processor 12 receives the archived content from the news source for a fee, and then passes the expense on to the user.

In yet another embodiment, users are not charged money for tools for developing personal Internet portal pages of the present invention. Moreover, users are not charged money for access to their personal Internet portal pages. Instead, a user agrees to allow personal portal information processor 12 to transmit information regarding the user to third parties. For example, when a user registers with personal portal information processor 12, he provides information that has value to third parties. The user submits information in a web data entry form such as the user's Internet-related preferences, professional experience, hardware and software tools he uses, annual income, and any other information suitable for a third party's benefit.

Moreover, in accordance with one business model of the present invention, the user agrees to allow personal portal information processor to transmit details regarding the user's selections that are incorporated into his personal Internet portal page. For example, personal portal information processor 12 provides a list for the user to choose from 50 news sources. The one or two specific sources the user selects are contacted and informed of the user's selection thereof. Such information is invaluable to information content providers who may otherwise be unaware of how the information they provide is disseminated. Such information can be used, for example, for future target advertising in ways unrelated to the use of personal Internet portal pages. It is envisioned, for example, that personal portal information processor 12 can provide statistical information for a plurality of sources directed to use of the present invention. Alternatively, details regarding content in the personal Internet portal page can be provided to third parties.

Thus, by using the information collected from users and their respective usage of personal Internet portal pages can be leveraged to generate revenue, without imposing advertising, promotional or other undesirable content in users' personal Internet portal pages. Further, users can be spared expenses for using the present invention by agreeing to allow personal portal information processor 12 to disseminate information about them.

In an alternative business model, revenue can be generated by charging by charging a fee to a content provider information processor 16 for providing a separate listing, known in the art as a “sponsored link.” In such a case, for example, a content provider information processor 16 identifies specific search terms that, when submitted by a user for a search, causes a link to the content provider information processor to appear in a designated portion of the display screen. Each time the user submits the respective search term and the sponsored link appears, the content provider information processor 16 (or the proprietor thereof) is charged a fee.

Preferably, the search engine provided for users on personal Internet portal pages is configured to provide lists of URLs that contain within them the search term(s) submitted by the user. Alternatively, the search engine provides lists of URLs in which the search term submitted by the user is provided somewhere in the respective URLs' web pages, for example in metatags, HTML text, or other elements of the web pages.

In another business model of the present invention, users provide credit card or other payment information to the personal portal information processor 12. The credit card (or other financial source) is automatically charge a fee when a user selects content for his personal Internet portal page that will incur an extra fee, such as archived content from a content provider information processor. The fee charged to the credit card company is paid into an account held by personal portal information processor 12, or a representative thereof. Preferably, the content provider information processor is paid from the account held by personal portal information processor 12.

Other uses and products provided by the present invention will be apparent to those skilled in the art.

Although the present invention has been described in relation to particular embodiments thereof, many other variations and modifications and other uses will become apparent to those skilled in the art. It is preferred, therefore, that the present invention be limited not by the specific disclosure herein.

1. A system for displaying a personal portal page, the system comprising:
an Internet content storage module operable to receive and store content from a pre-identified Internet web site in a memory;
a personal content storage module operable to receive and store content from a user in the memory;
a content selection module operable to receive a selection from the user representing at least one of the content from the Internet web site and the content from the user;
a portal page layout module operable to place only the content represented by the selection from the user in the personal portal page according to a predefined specification; and
a portal page layout modification module operable to receive input from the user that represents at least one change to the predefined specification, wherein the portal page layout modification module uses the input from the user to modify the predefined specification, and to display the personal portal page according to the modified predefined specification.

2. The system of claim 1, wherein the portal page modification module displays the personal portal page according to the predefined specification when no input from the user is received.

3. The system of claim 1, wherein the content from the pre-identified Internet web site includes a live feed of frequently changing information.

4. The system of claim 1, further comprising an Internet web site selection module operable to receive an identification of at least one Internet web site from the user, and providing at least one respective hyperlink to each of the at least one Internet web site.

5. The system of claim 4, wherein the portal page layout module is further operable to place the at least one respective hyperlink in the personal portal page according to the predefined specification.

6. The system of claim 1, further comprising a web site display module operable to display an Internet web site identified by the user according to a predefined specification.

7. The system of claim 6, wherein the predefined specification is provided by the user.

8. The system of claim 7, wherein the predefined specification represents a first interval of time when the web site is not displayed, and a second interval of time when the web site is displayed.

9. The system of claim 1, wherein the content from the user includes at least one of information content and multi-media content.

10. The system of claim 9, wherein the information content includes at least one of project management information and personal information.

11. A system for displaying a personal portal page, the system comprising:
an Internet content storage module operable to receive and store content from a pre-identified Internet web site in a memory;
a personal content storage module operable to receive and store content from a user in the memory;
a content selection module operable to receive a selection from the user representing at least one of the content from the Internet web site and the content from the user; and
a portal page layout module operable to receive input from the user that represents a specification for placing the content identified in the content selection module in a display, wherein the portal page layout module places only the content identified in the content selection module in the display according to the specification.

12. A system for displaying a personal portal page, the system comprising:
an Internet content storage module operable to receive and store content from at least two pre-identified Internet web sites in a memory;
a personal content storage module operable to receive and store content from a user in the memory;
a content selection module operable to receive a selection from a user representing the content from at least one of the Internet web sites and the content from the user; and
a portal page layout module, the portal page layout module operable to receive input from the user that represents a specification for placing the content identified by the content selection module in a display, wherein the portal page layout module places only the content identified in the content selection module in the display according to the specification.

13. The system of claim 12, further comprising a search engine.

14. The system of claim 13, further comprising an alert module.
